(19) United States
(12) Patent Application Publication
(10) Pub. No.: US 2011/0261249 A1
(43) Pub. Date: Oct. 27, 2011

(54) Variable sharpness optical system for sub-sampled image

(75) Inventors: Steven E. Saunders, Cupertino, CA (US); Bjorn Hori, Albany, CA (US); David Wong, Palo Alto, CA (US); John D. Ralston, Portola Valley, CA (US)

(73) Assignee: Droplet Technology, Inc., Palo Alto, CA (US)

(21) Appl. No.: 12/800,140

(22) Filed: May 6, 2010

Related U.S. Application Data
(60) Provisional application No. 61/176,092, filed on May 6, 2009.

(51) Int. Cl. H04N 5/232

(52) U.S. Cl. 348/345; 348/E05.045

(57) ABSTRACT

Methods and systems for capturing an image are disclosed herein.

### CROSS-RELATED APPLICATIONS

This application claims priority to U.S. Provisional Application 61/176,092, entitled, “Variable Sharpness Optical System for Sub-Sampled Image Capture,” filed on May 6, 2009, which is incorporated herein by reference in its entirety.

### FIELD OF THE INVENTION

This invention relates generally to imaging systems and methods for devices with camera systems. More particularly this invention relates to systems and methods for anti-aliasing in devices with camera systems.

### BACKGROUND OF THE INVENTION

Cell-phone (and other) digital image capture devices (imagers) have an array of photosensitive sites that can be called “pixels” (actually involving Bayer patterns and other complications). These sites sample the continuous optical image formed on the imager by a lens, or minor, or diffractive optical element, or combination of those.

Sampling is known to cause aliasing artifacts when the sampled signal (optical image) has spatial frequency components higher than the Nyquist limit. In image terms, this means that whenever the image formed by the lens on the imager array is too sharp for the sampling array, aliasing will result.

In common use, an imager is used to sample and deliver digital images at multiple resolutions: a selection of reduced resolutions in addition to the full resolution. For example, a 2 Megapixel imager (1920×1280 pixels) may be required to deliver VGA images for video (640×480 pixels) and also QVGA images for wireless video (320×240 pixels). In this case, the lens that is just right for the full resolution of the imager is “too sharp” for the lower resolution samplings and can cause aliasing.

### BRIEF DESCRIPTION OF THE DRAWINGS

To facilitate further description of the embodiments, the following drawings are provided in which:

FIG. 1 illustrates an example of a method of, according to an embodiment;

FIG. 2

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

An electrical “coupling” and the like should be broadly understood and include coupling involving any electrical signal, whether a power signal, a data signal, and/or other types or combinations of electrical signals. A mechanical “coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

According to one aspect of the invention, excess sharpness is removed physically (optically), by selectively or variably blurring an image formed on an imager array. This requires a lens or image-forming subsystem that is able to have its sharpness changed, having sharpness appropriate to the full imager resolution when a full-resolution capture is wanted (as for a still picture) and variable or switchable to a lower sharpness (or greater blur) when a lower, sub-sampled resolution is wanted (as for a video image sequence).

According to some embodiments, a “rest state” or default state of the image-forming system is a low-resolution state. This is because the blurry condition is wanted for video, which continues over longer periods of time, while the sharp condition is wanted for still pictures. Thus we get a lower expenditure of energy overall by altering the image-forming system for only a brief time during the exposure of a high-resolution still image, rather than holding the alteration during the exposures of a video sequence.

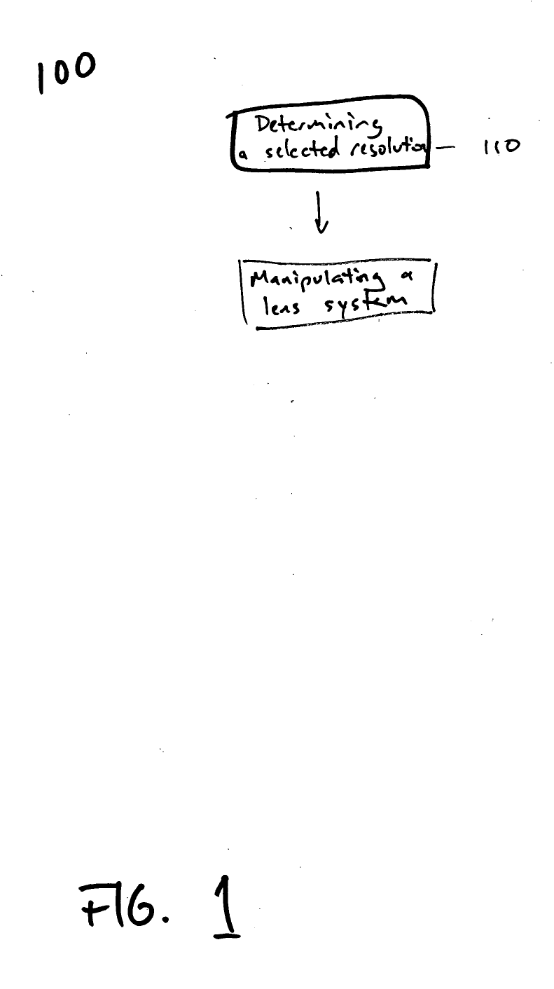

FIG. 1 shows an example of a method 100 of anti-aliasing. In the same or different embodiments, method 100 can be considered a method of optimizing the efficiency of a video monitoring or communication system. Method 100 is merely exemplary and is not limited to the embodiments presented herein. Method 100 can be employed in many different embodiments or examples not specifically depicted or described herein.

Method 100 can include a procedure 110 of determining a selected resolution. The resolution selected can be any resolution that a lens system is capable of providing. In many instances the desired resolution is less than the maximum resolution that the lens system is capable of providing. For instance, the imager array of a camera may not be able to sample images as sharp as the lens can deliver. In other instances, a lens system may be used for still images and video. Due to the processing of the video, full resolution images may not be able to be processed. In other instances, other roadblocks may determine that less than full resolution samples be taken. For example, the device that is to receive the image may not be capable of displaying the full resolution of the image delivered by the lens. In other examples, available bandwidth may limit the amount of data being transmitted to a receiving device, and, therefore, less than full resolution images must be transferred because of the smaller data size.

After procedure 110, method 100 can include a procedure 120 of manipulating the lens system. The lens system is manipulated to alter the sharpness of the image being displayed on the imager. The sharpness of the image is altered to correspond to the selected resolution that was determined during procedure 110. In some embodiments, the lens system is manipulates so that the sharpness of the image corresponds to a signal that has frequency components at or below a Nyquist limit for the selected resolution. Examples of procedures to manipulate the lens system can include:

1. Focus

According to one embodiment, a lens is moved toward or away from the imager (or image plane) so as to throw the image out of focus. This technique, however, may not be preferred. For example, objects located closer or further away from the image plane distance will then be brought into sharp focus, while the user may want to focus at a particular distance (having other distances “out of focus”) but still capture images without aliasing. A variant of these embodiments is to focus “beyond infinity” (i.e. a lens are brought closer to the imager than infinity focus).

2. Deformation

According to another embodiment, the curvature of a lens or mirror is altered, e.g., bending a mirror or lens. More generally, one or more component(s) of the lens or image forming subsystem is selectively deformed by a preset amount in order to reduce the sharpness of the image by introducing or increasing the aberrations of the lens design. For example, a lens or part of a lens can be made of a soft, easily-bent material. A variant of these embodiments is to bulge a lens element.

3. Shift

According to another embodiment, it can be arranged to move an element of a multi-element lens to a position within the image-forming subsystem that introduces or increases the aberrations of the lens design. The lens fails to produce a perfect (diffraction-limited) image.

4. Liquid

According to another embodiment, one can make the lens or part of it out of a liquid-meniscus material and vary the focus of this liquid component.

5. Rings or Zones

According to another embodiment, one can arrange a concentric set of annular areas in the lens/IFS so that for full resolution, only the central zone is used, and for lowered resolution an outer ring or zone is enabled. This has the additional nice property that when one reduces resolution he or she increases the light transfer of the system. According to this aspect of the invention, there is a novel lens element, or lens assembly configured for selectively varying the sharpness of an image received on an image plane.

6. Variable Aperture

According to another embodiment, one can make the lens have good sharpness when “stopped down” using an iris or variable aperture, but have less sharpness when the iris or aperture is made larger. This has the same nice property as the previous arrangement. As is known in the art, a digital imager may not have a variable aperture or other light-quantity-control means, but rather use electronic gain controls, sometimes called “AGC” for Automatic Gain Control.

7. Vibration or Motion

According to another embodiment, one can vibrate or move the lens and/or the imager with an amplitude sufficient to produce the wanted degree of blur and with a frequency or speed higher than the effective exposure time for sampling, so that the sharp image is smeared across the imager and each sampling point gets light from several places in the image. Movement can be in the image plane, or tilting movement. In-plane motion is preferably circular or in a pattern that covers a nearly-circular area within the exposure time. Tilting motion is preferably nutating or in a pattern that covers a nearly-circular solid angle within the exposure time.

8. Wavefront Coding

There are known ways to make an optical system that produces an image which, while unsharp, can be digitally processed to extract a sharp image (and indeed, an image sharp over an extended depth of field, which is the motivation for the system). According to another embodiment, one can exploit such an imaging system's unprocessed unsharpness to select appropriate samples for the low-resolution output without further processing.

9. Refractive Index Change

Liquid-crystal materials can be made to change their refractive index under electric field changes. A LC element in a lens can thus change its effective optical power, allowing adjustment of image sharpness to compensate for the sample rate.

10. Switchable Scattering

Liquid crystal materials can be mixed in passive optical materials so that when switched in one state, the composite is clear but when switched to another state the composite scatters light. Such a composite may be adjusted so that the scattering is of suitable magnitude for sub-sampling.

11. Acoustic Deformation

One can transmit acoustic energy into an optical element, bending or bulging it in a vibratory fashion. For instance, vibration applied to the edge of a minor element can propagate across the mirror surface, changing the focus or aberrations of the optical system.

12. Interposed Element

One can mechanically insert into the optical path an optical element (lens, minor, diffractive element, scattering element, or filter) that modifies the imaging sharpness of the optical system when present. This element can be coupled to a lever or switch on the product package. The lever or switch can at the same time set the operation of the device to “still picture” or “video capture” mode and insert or remove the optical element appropriately. The mechanical switch can also include a protective cover for the lens and a “camera off” position with the cover in place. The element can alternatively be moved into and out of the optical path under electronic control.

All of the mechanical movements in these embodiments can be implemented in conjunction with hard stops for the respective operating positions of the movable elements, and with spring bias against the stops, either toward one default position or bi-stable spring bias toward each operating position.

In preferred embodiments, the variable sharpness optical system is incorporated into an imager for a mobile device, such as a cell-phone and similar handset. The imager according to some embodiments the mobile device includes an all software encoder that uses a wavelet transform the image data.

Although many specific examples of procedures for manipulating the lens system were listed, the list is not exhaustive. Other similar procedures may be used to manipulate the lens system.

Next, method 100 continues with a procedure 130 of electronically filtering the image. Procedure 130 can be optional. Examples of electronically filtering the image can include point sampling and binning.

After procedure 130, method 100 can include a procedure 140 of sampling the image. Many methods of sampling are known in the art.

Subsequently, method 100 includes a procedure 150 of compressing the image signal. There are many ways to compress data known in the art. In some examples, techniques developed by Droplet Technology, Inc. are used. By altering the resolution of the image that is sampled when the lens system is manipulated, the amount of compression that is needed is reduced, thereby making the compression much more efficient and less costly.

Next, method 100 can include a procedure 160 of sending the data to a recipient. The data can include the compressed image or multiple images. In many instances, the data is video taken from the camera and can also include audio. The data can be sent any number of ways, including, for example, over a wireless network.

After procedure 160, method 100 can comprise a procedure 170 of receiving the data. The data can be received on any device capable of receiving the data. For example, the data can be received on a mobile device, such as, for example, a mobile phone, a smart phone, a mobile media device, etc. In some examples, the receiving device can also be equipped with a camera system. Therefore, the receiving device can also perform the procedures of method 100 that require the data to be gathered and sent (e.g., procedures 110-160). This is valuable in situations where method 100 is being performed during video conferencing and the like. In addition, procedure 170 can include decompressing the data send and displaying the data sent.

After procedure 170, method 100 is complete. However, it should be noted that the method can repeat itself. Furthermore, any number of procedures of method 100 can be performed at any time. For example, each procedure of method 100 can be performed at the same time and for a continuous period of time.

In addition, other procedures not specifically mentioned herein can be included in method 100. For example, there can be additional filtered after the image has been sampled in procedure 140.

Furthermore, in some embodiments, method 100 can be optimized. For example, procedure 110 can be take into account other of the procedures in method 100 to determine the selected resolution of the lens system. For example, different procedures may have different maximum resolutions that can be processed. In some cases the receiving device has a maximum resolution that can be displayed, while the bandwidth has a different maximum resolution that can be passed, and the camera system has yet another maximum resolution that it is capable of processing for video. Each of these different resolutions can be evaluated and the smallest of these resolutions can be selected. This will enable the camera system to operate at maximum efficiency.

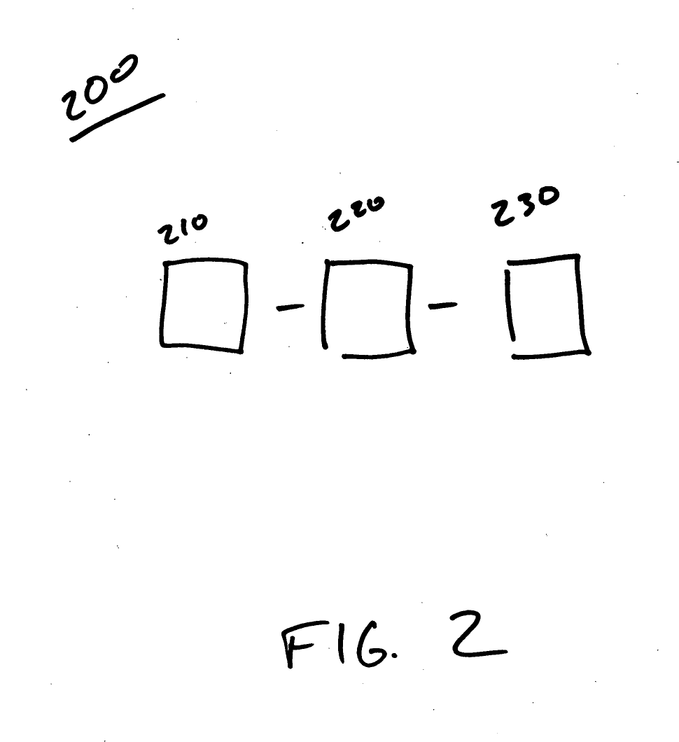

FIG. 2 shows an example of a system 200 for anti-aliasing. System 200 is merely exemplary and is not limited to the embodiments presented herein. System 200 can be employed in many different embodiments or examples not specifically depicted or described herein.

System 200 can comprise a lens system 210, an imager 220, and a compression unit 230.

In some embodiments the present invention comprises methods, systems and apparatus for using lens and imager systems to facilitate capturing relatively higher resolution images from the imager for a first image condition (such as still images) and also capturing relatively lower resolution images from the same imager for a second image condition (for example, such as video frames). The methods, systems and apparatus can be applied to provide images of different sharpnesses to the imager for each of the two image conditions. For example, in some embodiments the lens can be manipulated or configured to provide an image to the imager having a relatively higher sharpness when images of a relatively higher resolution are taken from the imager (such as in the first condition). Additionally, the lens can be manipulated or configured to provide an image to the imager having a relatively lower sharpness when images of a relatively lower resolution are taken from the imager (such as in the second condition.)

In some embodiments the invention can be applied in the scenario of an imager used for both still and video images, such as, for example, an imager in a cell phone, security camera or other imager or camera. Frequently, in such scenarios, the images from the imager are subjected to compression operations to facilitate transmission, storage or other use of the images. According to aspects of certain embodiments of the present invention, relatively high resolution images can be taken or received from the imager and used for still pictures and relatively low resolution images can be taken or received from the imager and used as frames for video imaging.

In one exemplary embodiment, a cell phone imager is used. The imager can capture 5 megabit photos. In a first condition a lens system is manipulated to provide a relatively sharp image to the imager and a 5 megabit photo image is obtained from the imager. This image can be sent to a compression unit for compression prior to transmission of a compressed version of the image from the phone or prior to storage of a compressed version of the image. In a second condition the lens system is manipulated to provide a relatively lower sharpness image to the imager and a 640×480 bit image is obtained from the imager. This image can be sent to a compression unit, including for example the compression unit of the first condition, for compression prior to transmission of a compressed version of the image or storage of a compressed version of the image. Since the image provided by the lens system to the imager in the second condition is of relatively lower sharpness than in the first condition, significant aliasing problems are avoided when the 640×480 image is obtained from the imager. Additionally, the lower resolution image (for video) can be compressed with lesser compression operation expenditures than could be video frames of 5 megabit sizes.

This is particularly useful in video capture, compression and viewing systems. When the target viewing of the video captured by the imager will be only at a certain predetermined resolution (e.g., VGA) then the lens system can be manipulated to provide a sharpness facilitating capture at VGA resolution with reduced aliasing effects as described above—even when a higher or much higher resolution imager is used for capture of the video.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the methods, systems, and devices discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for capturing an image, comprising:
determining a selected resolution; and
manipulating a lens system to adjust a sharpness of an image received from the lens system by an imager;
wherein
the imager will produce a representation of the image at the selected resolution when the lens system delivers the image to the imager.

2. The method of claim 1, wherein:
determining the selected resolution comprises determining a maximum resolution of the imager.

3. The method of claim 1, wherein:
determining the selected resolution comprises determining a maximum resolution of a display screen.

4. The method of claim 1, wherein:
determining the selected resolution comprises determining a maximum resolution that corresponds to a minimum bandwidth through which a compressed version of the image will pass.

5. The method of claim 1, wherein:
manipulating the lens system comprises deforming the lens system.

6. The method of claim 1, wherein:
manipulating the lens system comprises shifting at least one element of the lens system.

7. The method of claim 1, wherein:
manipulating the lens system comprises varying the focus of a liquid component of the lens system.

8. The method of claim 1, wherein:
manipulating the lens system comprises using a lower resolution zone on the lens system to produce the image.

9. The method of claim 1, wherein:
manipulating the lens system comprises introducing a movement into at least one of the lens system or a minor element.

10. The method of claim 1, wherein:
manipulating the lens system comprises at least one of increasing the size of an aperture or an iris, or adjusting an automatic gain control.

11. The method of claim 1, wherein:
manipulating the lens system comprises adjusting an effective optical power of at least one liquid crystal element of the lens system.

12. The method of claim 1, further comprising:
electronically filtering the imager before the image is received on the imager.

13. A system, comprising:
a lens system;
an imager; and
a compression unit;
wherein:
the lens system is configured to operate in a first condition and a second condition;
the lens system delivers a first image to the imager at a first sharpness when in the first condition and a second image to the imager at a second sharpness when in the second condition; and
the imager transmits the first image at a first resolution to the compression unit when the lens system is in the first condition and the second image at a second resolution to the compression unit when the lens system is in the second condition.

14. The system of claim 13, wherein:
the first condition is a still image;
the second condition is video; and
the first resolution is greater than the second resolution.
